(19) United States
(12) Patent Application Publication
(10) Pub. No.: US 2002/0159013 A1
(43) Pub. Date: Oct. 31, 2002

(54) Twisted nematic micropolarizer and its method of manufacturing

(76) Inventors: Sadeg Faris, Pleasantville, NY (US); Adam Divelbiss, Wappingers Falls, NY (US); David Swift, Cortlandt Manor, NY (US); Le Li, Yorktown Heights, NY (US); Ying Zhou, Bedford Hills, NY (US); Yingqui Jiang, Sunnyvlae, CA (US); Zongkai Wang, Port Washington, NY (US)

Correspondence Address: Reveo, Inc., 85 Executive Blvd., Elmsford, NY, 10523, US

(21) Appl. No.: 10/045,871

(22) Filed: Jan. 14, 2002

Related U.S. Application Data
(60) Provisional application No. 60/261,135, filed on Jan. 12, 2001.

(51) Int. Cl. G02F 1/1337

(52) U.S. Cl. 349/124

(57) ABSTRACT

The invention is a method for creating a micropolarizer, including providing a first plate having a first and a second surface, providing a second plate having a first and a second surface. Then coating a polyimide on each of the first surface of the two plates followed by rubbing the polyimide coated upon the first surface of the first plate along a predetermined direction and rubbing the polyimide coated upon the first surface of the second plate along a direction having a predetermined angle in relation to the predetermined direction. An alignment process includes aligning the first plate and the second plate having the first surface of the first plate and the first surface of the second plate facing each other thereby creating a space there between. In conclusion there is a filling of a liquid crystal between the space whereby a cell, or film is created.

### CROSS REFERENCE TO RELATED APPLICATIONS

This application is related to provisional application 60/261,135 filed Jan. 12, 2001 and is hereby incorporated by reference.

### BACKGROUND OF THE INVENTION

This disclosure summarizes the invention relating to the development and manufacturing of micropolarizers (μPol™) based on twist nematic (TN) liquid crystals.

Reveo Inc. has previously invented, developed, and commercialized a 3D-display technology using a micropol (μPol) panel in which patterned polarizers having alternate lines of perpendicular polarization are used in conjunction with polarizing glasses. In this technique, polyvinyl alcohol (PVA) λ/2 retarder has been the base for building the μPol array. The fundamentals of this μPol rely on the π phase shift induced by PVA. The μPol is built in such a way that it consists of alternately spaced lines with and without the π phase shifter, as schematically shown in FIG. 1.

The advantages of such a μPol include:

Simple processing;

Low cost;

High throughput;

However, the PVA based μPol has its own shortcomings:

Poor spectral characteristics due to the phase shift mechanism;

Relatively thicker film thickness;

Relatively low spatial resolution;

Difficulty in line width control;

Poor thermal and humidity resistance.

This invention describes an alternative method to manufacture a high quality μPol that will essentially eliminate all the above-mentioned problems.

### BRIEF SUMMARY OF THE INVENTION

The invention is a method for creating a micropolarizer, including providing a first plate having a first and a second surface, providing a second plate having a first and a second surface. Then coating a polyimide on each of the first surface of the two plates followed by rubbing the polyimide coated upon the first surface of the first plate along a predetermined direction and rubbing the polyimide coated upon the first surface of the second plate along a direction having a predetermined angle in relation to the predetermined direction. An alignment process includes aligning the first plate and the second plate having the first surface of the first plate and the first surface of the second plate facing each other thereby creating a space there between. In conclusion there is a filling of a liquid crystal between the space whereby a cell, or film is created.

### BRIEF DESCRIPTION OF THE DRAWINGS

FIG. 1 illustrates a schematic of a PVA retarder based on μPol technology;

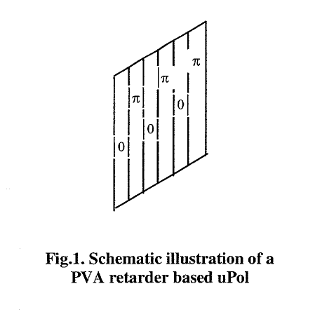

FIG. 2 illustrates optical rotation by a TN liquid crystal cell;

FIG. 3 illustrates the transmittance of PVA films and TN cell versus wavelength;

FIG. 4 illustrates a schematic of a TN based μPol;

FIG. 5 illustrates a TN based μPol made with the UV mask method;

FIG. 6 illustrates TN based μPol made with the E-field alignment method;

FIG. 7 illustrates a TN based μPol made with the multi-rubbing method;

FIG. 8 illustrates a TN μPol with 260 μm line width made by two-step UV exposure method;

FIG. 9 illustrates a TN μPol with 60 μm line width made by Multiple-Rubbing Method;

FIG. 10 illustrates a TN-μpol made using a flexible linear polarizing sheet as one substrate and a non-birefringent Sheet as the other substrate;

FIG. 11 illustrates a TN-μpol fabricated directly on an LC display;

FIG. 12 illustrates a 45-Degree micropol;

FIG. 13 illustrates a horizontally aligned TN-micropol;

FIG. 14 illustrates a vertically aligned TN-micropol for vertical display pixel or sub-pixel columns; and

FIG. 15 illustrates a checkerboard TN-micropol aligned vertically and horizontally.

### DETAILED DESCRIPTION OF THE INVENTION

Principals of TN Liquid Crystal

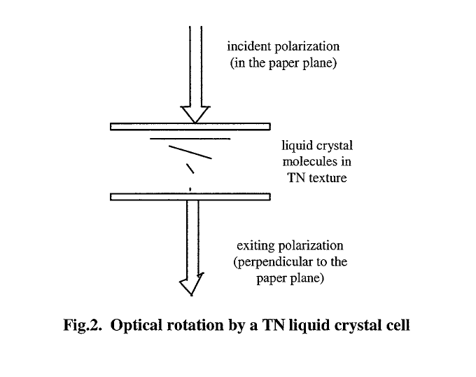

When twisted nematic (TN) cells satisfy the Mauguin condition, the incident linearly polarized light can be considered to rotate with the liquid crystal molecules. For a 90° TN cell, the Mauguin condition is 2Δnd>>λ, in which d is the cell thickness, λ is wavelength of incident light and Δn is birefringence, respectively. A TN film rotates the polarization axis of linear incident light by 90°, as shown in FIG. 2.

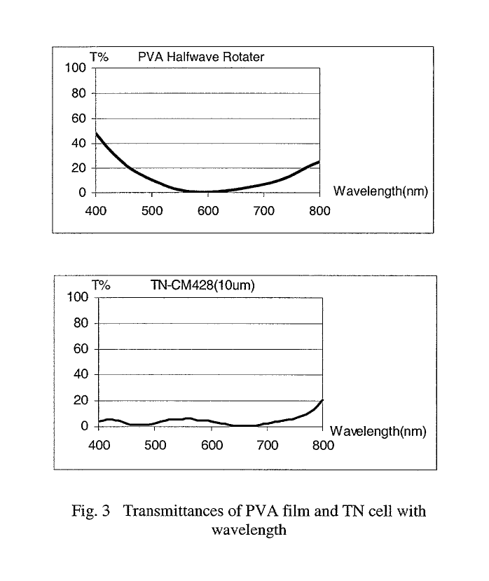

In a 90° TN cell, liquid crystal molecules are oriented in such a way that the top layer is aligned in one direction while the bottom layer is perpendicularly aligned. The optical rotation by the TN cell exhibits much less wavelength dependence than that of a λ/2 retarder. In other words, the bandwidth of a TN cell is much wider than that of a retarder, as shown in FIG. 3. FIG. 3 shows the transmittance curves of PVA λ is wavelength of incident light and Δn is birefringence, respectively. A TN film rotates the polarization axis of linear incident light by 90°, as shown in FIG. 2.

In a 90° TN cell, liquid crystal molecules are oriented in such a way that the top layer is aligned in one direction while the bottom layer is perpendicularly aligned. The optical rotation by the TN cell exhibits much less wavelength dependence than that of a λ/2 retarder. In other words, the bandwidth of a TN cell is much wider than that of a retarder, as shown in FIG. 3. FIG. 3 shows the transmittance curves of PVA film and a TN cell as a function of the wavelength, in which the transmittance measurement was taken by inserting the PVA film and the TN cell between pairs of parallel linear. The thickness of TN cell is 10 um and polymerizable liquid crystal CM428 is used and cured by UV light.

The TN film can be made relatively thin, typically, in the range of 5μ, as compared to 37.5μ of a commercial retarder from Polaroid. Such a thin layer is most suitable for constructing a high resolution μPol. Generally, liquid crystal materials used in display systems have excellent thermal as well as humidity resistance. Furthermore, if the TN cell is built with polymerizable (UV curable) liquid crystal, it can be peeled off from the glass substrates and can be transferred to other surfaces.

TN μPol has the advantages of PVA μPol and overcomes the shortcomings of PVA μPol. The advantages of TN μPol are listed below:

Good spectral characteristics in the wide band;

Thin film thickness. By choosing large birefringence liquid crystal material, TN uPol film can be very thin and exhibit the wide bandwidth property.

High spatial resolution;

Small transition regions;

Easy to control line width;

Good thermal and humidity resistance;

Simple processing, low cost and high throughput.

TN Liquid Crystal Based μPol

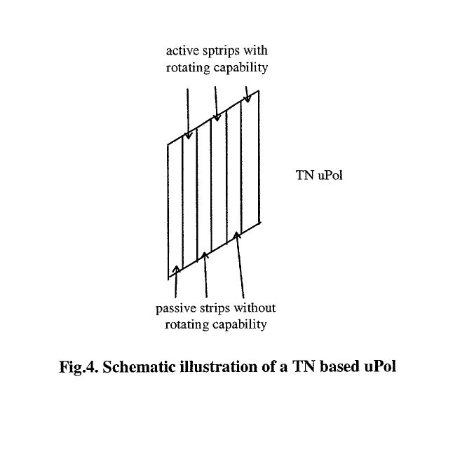

If a TN film is patterned to have alternatively spaced lines with and without the optical rotation capability, a new uPol is created, as shown in FIG. 4.

In the active strips in FIG. 4, liquid crystal molecules are twisted so that they rotate the polarization angle of incident light. However, in the passive strips, molecules are un-twisted either in an isotropic phase or homogeneous or homeotropic phase so that they are unable to rotate the polarization.

TN uPol Processing

There are several ways to process a TN into a μPol. Four preliminary methods have been proposed. They are:

Two-step UV exposure;

E-field (electric field) alignment;

Multiple-rubbing; and

Photo-induced alignment.

The following sections describe the fundamental details regarding the four processing are described.

Two-step UV Exposure Method

This method uses a two-step UV exposure procedure to create a μPol which consists of nematic lines in a twist and an isotropic state, respectively. The method involves the following steps:

Coat polyimide on two glass plates;

Rub the polyimide coatings;

Make a cell with the two plates in such a way that the polyimide rubbing direction of one plate is orthogonal to each other;

Fill in polymerizable nematic liquid crystal with light chiral concentration so that a TN cell (film) is made;

Cover the TN cell with a mask which has an alternatively spaced opaque and transparent strips;

Using a UV light to polymerize the nematic liquid crystals under the transparent area into a permanent twist texture;

Remove the mask;

Heat the cell higher than the nematic-isotropic transition temperature so that those un-polymerized nematics covered by the opaque mask strips experience a transition into the isotropic phase, resulting in un-twisting of the liquid crystal molecules. The twisting texture of the polymerized nematics remains un-changed.

Finally, re-polymerize the previously uncured nematics into isotropic phase.

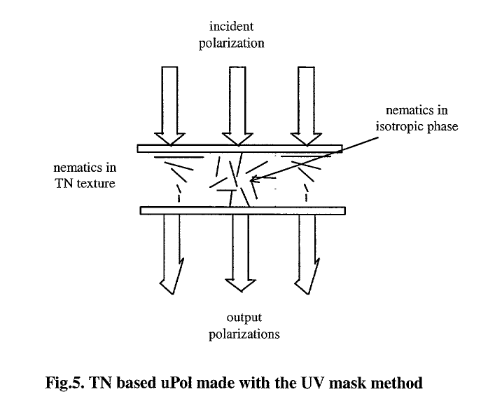

The resulting uPol will have the features as shown in FIG. 5. This method can only be realized using the polymerazible nematic liquid crystal.

E-field (electric field) Alignment Method

In this method, an E-field is applied to a pre-patterned ITO electrode to create a uPol that contains nematic lines in twist and homeotropic structure, respectively. The detailed procedures involve the followings:

Using photolithography methods, pattern one ITO glass plate to have an alternatively spaced strips with and without ITO;

Coat polyimide on this patterned ITO glass and on another un-patterned ITO glass plate;

Rub the polyimide in the proper directions;

Make a TN cell with the two glass plates with rubbing directions perpendicular to each other;

Fill in nematic liquid crystal;

Apply an E-field to vertically align the nematic liquid crystal under the stripped ITO electrodes. The nematic liquid crystal under the strips without ITO remains in a TN texture.

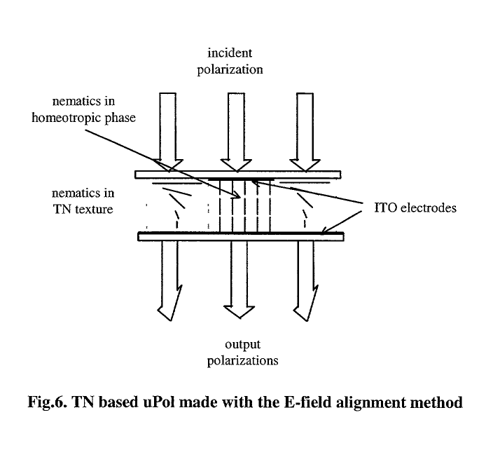

The final texture of a μPol constructed with this method is illustrated in FIG. 6.

Multiple-Rubbing Method

Patterned polyimide strips are created which have orthogonal rubbing direction so that liquid crystals under one strip are aligned into a twist texture while the nematics under adjacent strips are aligned into a homogeneous texture. A suitable polyimide must be used which the photolithography process will not ruin. This method is outlined in the following steps.

Coat polyimide (SE 7311 from Brewer Scientific or other suitable polyimide) on one glass substrate;

Unidirectionally rub the polyimide coating;

Coat photo resist (S 1815 from Microposit or other suitable photo resist) on top of the rubbed polyimide;

Pattern the photo resist via photolithography to have alternating spaced strips;

Re-rub the polyimide left un-covered by the photo resist strips in a perpendicular direction to the first rubbing direction;

Remove all the photo resist by rinsing in an acetone bath;

Make a cell with the patterned glass plate and another unidirectionally rubbed polyimide glass plate;

Fill the cell with nematic liquid crystal to form a uPol with alternative strips in TN and homogenous texture.

If polymerizable liquid crystal is filled, cure the TN cell with a suitable UV light.

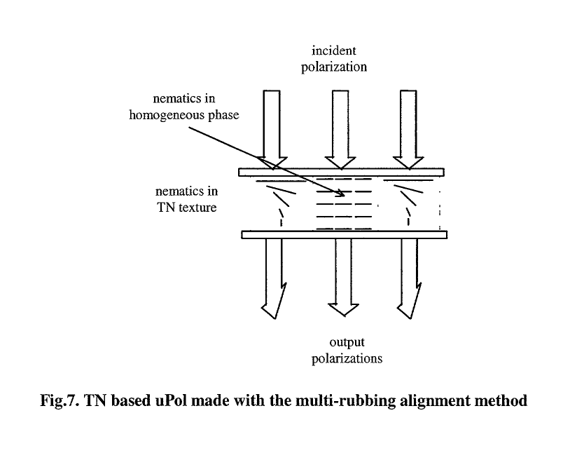

The resulting uPol has the texture shown in FIG. 7.

Photo-induced Alignment Method

Recently the possibility to align LC cells using photosensitive orientants has been paid a lot of attention. Because of its noncontact and easy to pattern properties, this method has some advantages over rubbed polymer films. Some materials, such as polyvinyl 4-methoxycinnamate (PVMC), polyvinylcinnamates (PVC), some polyimides, dyed polyimide, and azobenzene polymer, were found to have the capability to align liquid crystal molecules after exposure under linear polarization UV light. Liquid crystal molecules align in the direction perpendicular to the polarization direction of the UV light. There are several ways to realize TN uPol by photo-induced alignment method that are described in detail below.

A. Two-step Exposures with Linearly Polarized UV Light

For many of the photo-induced alignment materials mentioned above, if they are exposed to linearly polarized UV light in different direction of polarization for two times, they have a property to let liquid crystal molecules align in the direction perpendicular to second exposure direction. Therefore, this property provides a very easy way to make TN uPol. The detail steps are given below:

Coat the suitable photo-induced alignment material onto two glass plates and subsequently bake.

Expose both plates to linearly polarized UV light.

With the mask placed over the plate, expose one of the plates again under linearly polarized UV light with a polarization direction perpendicular to the initial polarization direction.

Fabricate the cell and fill with the nematic liquid crystal.

For those materials that liquid crystal cannot align properly corresponding second exposure, a different procedure can be followed:

Coat the suitable photo-induced alignment material onto a two glass plate bake.

Expose one plate to linearly polarized UV light.

Expose another plate to linearly polarized UV light with the mask placed over the plate, move the mask half period precisely and then expose with linearly polarized (in a direction perpendicular to the initial polarization direction) UV light again.

Fabricate the cell and fill with the nematic liquid crystal.

B. Rubbing and Exposure with UV Linearly Polarized Light

In this method, rubbing processing and photo-induced alignment method were combined to produce TN μPol. The following involves the detail.

Coat the proper photo-induced alignment material on two glass plates followed by a thermal curing and mechanical rubbing;

Pattern one of the glass substrate by shining it through a mask with a light polarized in parallel to the rubbing direction;

Make a cell with such a patterned glass plate and another uniformly rubbed polyimide plate;

Fill in twist nematic material to form a μPol.

C. Bulk Alignment

In this method, the small amount of photoresist PVMC or azo dye is directly mixed into the nematic liquid crystal. When shined by a linearly polarized light, nematic molecules are perpendicularly aligned to the polarization direction. The followings are the detailed steps.

Coat polyimide onto two glass plates followed by a bake and rubbing;

Make a liquid crystal cell with the rubbed polyimide glass plates;

Fill in nematics;

Shine the cell through a mask with a linear light polarized perpendicularly to the rubbing direction to form a μPol.

The final texture of above μPol will be the same as shown in FIG. 7. Table I summarize the features of all the TN based uPol's made with the four methods described above, respectively.

TABLE I
Summary of the μPol's processed by the four methods

| | Recommended | | |
|---|---|---|---|
| Method | appl. | Advantages | Disadvantages |
| Photo-mask | will fit most | Simple | Relatively low |
| | applications | processing | resolution |
| | | No ITO glass | |
| | | Good thermal | |
| | | stability | |
| | | Low cost | |
| E-field | High resolution | High resolution | Relative |
| | applications. | Good thermal | complicated |
| | | stability | procedure |
| | | | Possible |
| | | | birefringence by |
| | | | those nematics |
| | | | in homeotropic |
| | | | state. |
| | | | Need ITO glass |
| | | | LC must have |
| | | | Δε ≠ 0 |
| Multi-rubbing | High resolution | Relative high | Relatively |
| | applications. | resolution | complicated |
| | | No ITO glass | procedure |
| | | Good thermal | Possible |
| | | stability | birefringence by |
| | | | those nematics |
| | | | in homogeneous |
| | | | state (ECB). |
| Photo-induced | High resolution | Simple | Possible |
| alignment | applications. | processing | birefringence by |
| | | High resolution | those nematics |
| | | No ITO | in homogeneous |
| | | Good thermal | state (ECB). |
| | | stability | Dye must be |
| | | | outside the |
| | | | visible region. |

Pictures of TN uPol

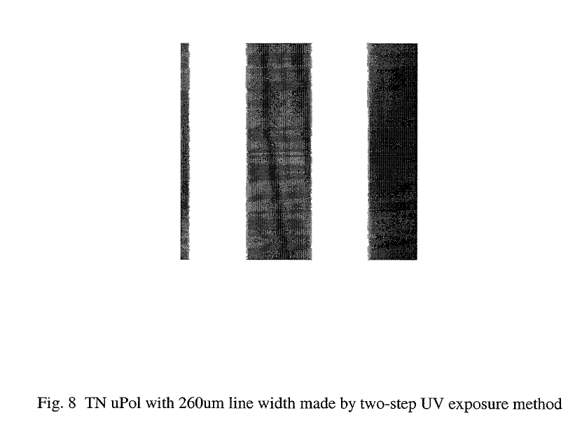

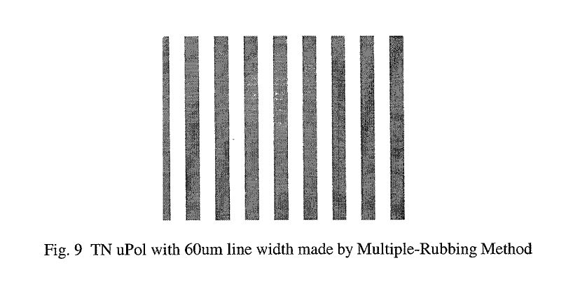

Two TN uPol pictures are shown below, which are observed with a crossed polarized microscope. FIG. 8 is a TN μPol with 260 μm line width made by two-step UV exposure method. The white parts show TN texture while the dark parts express the isotropic phase of nematic. FIG. 9 is another TN μPol with 60 um line width made by multiple-rubbing method. Similarly, the white parts show TN structure but the dark parts indicate homogenous alignment.

Using A Passive Linear Polarizer as the Substrate

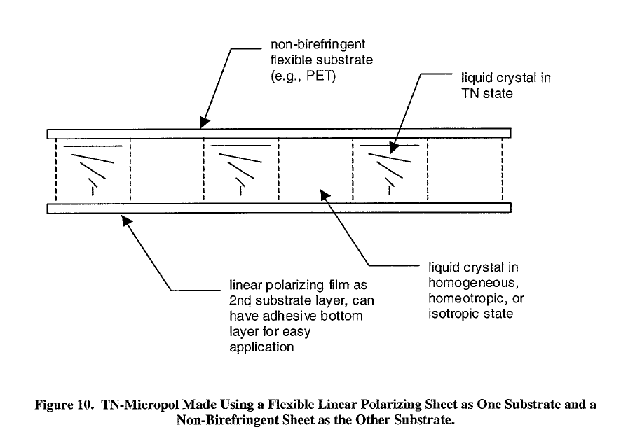

The TN-micropol may also be constructed using a passive linear polarizer as one substrate of the patterned TN-liquid crystal cell as shown in the figure below. Potentially each of the four methods described for fabricating a TN-micropol in the main disclosure can be used for this method. The resulting TN cell would be a flexible layered film that could be applied to a LCD display at the time of its manufacture. The process for construction of such a TN-micropol structure would depend on which of the four methods described above is chosen. FIG. 10 illustrates this construction method.

The peel able version of the TN micropol could also be realized using this structure if polymerizable TN liquid crystal were used in the fabrication.

The advantage of this method is that TN-micropol could be fabricated in large sheets or rolls and adhered to the LC display and the time of its manufacture. This structure would replace the normal analyzer (polarizer used on the output of the display). Anti-glare measures could be used on the non-birefringent substrate of this micropol structure to reduce glare as is done on a regular LC display.

Fabricating A TN-Micropol Directly on the LCD

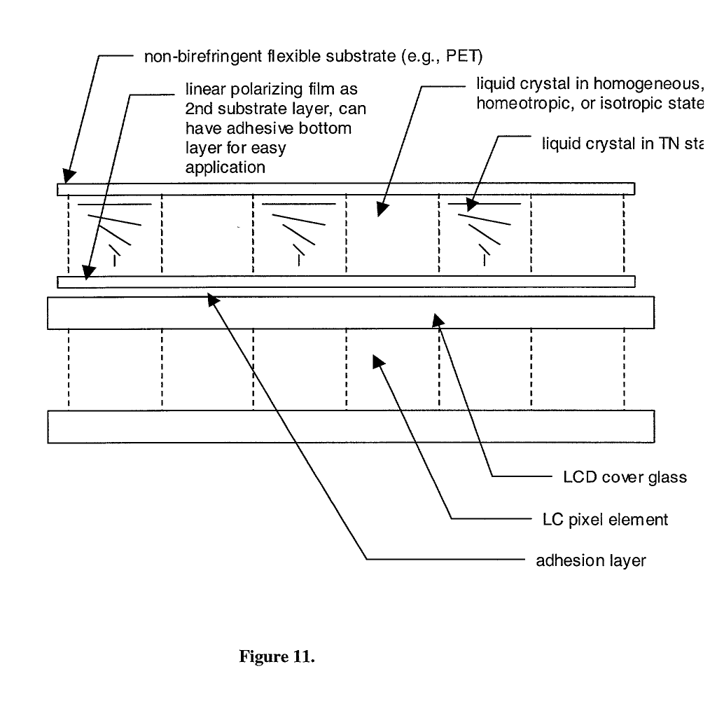

An alternative to the previous method is fabrication the TN-micropol directly on the LC display using the display itself as one substrate and a non-birefringent layer as the second substrate. As in the previous method, it is possible to use each of the fabrication methods (two-step UV exposure method, e-field alignment method, multiple rubbing direction method, and photo induced alignment method) to make the TN-micropol directly on the display. The advantage of this method is that the micropol can be accurately fabrication on the display as an additional step in the LC display manufacturing process. FIG. 11 illustrates this fabrication method.

TN-Micropol Types

In addition to the processes used to make the TN-micropol there are several types of TN-micropols that are covered by this invention including:

Two-Substrate type: In this case the micropol uses two glass substrates and non-polymerizable LC material. The advantage is that lower cost LC can be used.

Variation 1: both glass substrates are the same thickness

Variation 2: the glass substrate closest to the display is made thinner to increase the viewing angle by reducing the parallax effect.

Single-Substrate type: polymerizable LC material is used to so that one substrate can be removed. Removing the substrate increases the viewing angle by reducing the distance between the TN-material and the active elements of the display.

Electrically-switchable type: Using the E-field manufacturing process the micropol can be constructed to switch between 2D and 3D. When no electric fields is applied, the entire micropol acts as a singe LC cell causing all of the light from the display to be rotated by 90°. When the electric field is applied, the LC material between the patterned ITO electrodes enters the homeotropic phase and therefore do not rotate the polarization angle. A user can switch between 2D and 3D modes by activating a switch that controls the electric field.

Variation of E-field Process

A variation of the E-field process would use polymerizable liquid crystal to fabricate the micropol as follows:

Perform the previously described steps to make the cell.

Fill the cell with polymerizable LC material.

Apply the E-field to cause LC material between ITO electrodes to enter the homeotropic phase.

Cure the polymerizable LC material using strong UV radiation.

Release the e-field.

Post processing and cleanup.

This method may be used to make the Single-Substrate type TN micropol.

45-Degree TN Micropol

The existing application pertains to a 0°-90° TN-micropol in which alternating lines rotate the polarization angle by either 0° or 90°. Another type of micropol can be constructed using all of the methods presented above in which alternating lines rotate the polarization angle by either −45° or +45°. A representative drawing is shown in Figure ______. Vertically polarized light enters from behind the micropol and is rotated to −45° or +45° depending on the row.

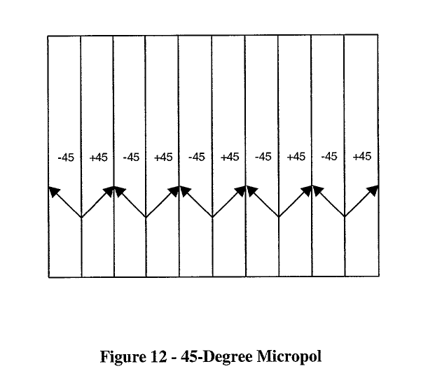

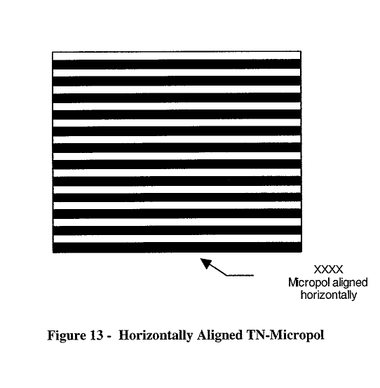

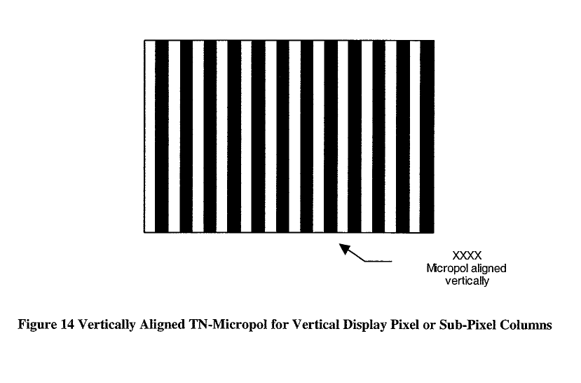

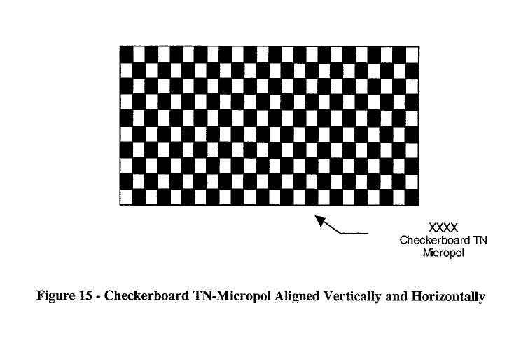

Finally it should be noted that the micropol lines may be oriented either vertically or horizontally. When horizontal lines are used, the micropol is positioned to exactly line up over horizontal lines of the display. When vertical lines are used, the micropol is positions such that it lines up exactly over the vertical columns of the display. Furthermore, the micropol line pitch may also be designed to coincide with vertical columns of red, green, and blue pixel elements of the display. Finally the TN micropol may be designed in a checkerboard pattern. These variations are shown in FIGS. 12 to 15.

The following references may be relevant to the disclosure and application and are hereby incorporated by reference. U.S. Pat. Nos. 5,537,144 and 5,844,717 issued to Sadeg Faris. An article by S. M. Faris, in the SID 91 Digest, p. 840. An article by B. Bahadur, entitled Liquid Crystals Applications and Uses, published by World Scientific, 1990, p232. A book by P. G. DE Gennes, entitled The Physics of Liquid Crystals, published by Clearendon Press Oxford, 1993. An article by T. Y. Marusii and Y. A. Reznikov in Mol. Mat., Vol. 3, p. 161, 1993. An article by M. Schadt, H. Seiberle and A. Schuster, in Nature, Vol. 381, p. 212, 1996. An article by S. C. Jain and H. S. Kitzerrow, Appl. Phys. Lett. 64 (22), p. 2946, 1994. An article by W. M. Gibbons, P. J. Shannon, S. T. Sun and B. J. Swetlin, Nature, Vol 351, p. 49, 1991. An article by G. P. Bryan-Brown and I. C. Sage, Liquid Crystals, Vol. 20, No. 6, p. 825, 1996. An article by K. Aoki, American Chemical Society, Vol. 8, p. 1014, 1992. An article by M. Schadt, H. Seiberle, A. Schuster and S. M. Kelly, Jpn. J. Appl. Phys., Vol. 34, p. L764, 1995.

While the invention has been described with reference to preferred embodiments, it will be understood by those skilled in the art that various changes may be made and equivalents may be substituted for elements thereof without departing from the scope of the invention. In addition many modifications may be made to adapt a particular situation or material to the teachings of this invention without departing from the essential scope thereof. Therefore it is intended that the invention not be limited to the particular embodiments disclosed as the best mode contemplated for this invention, but that the invention will include all embodiments falling with the scope of the appended claims.

What is claimed is:

1. A method for creating a micropolarizer, comprising:
providing a first plate having a first and a second surface;
providing a second plate having a first and a second surface;
coating a polyimide on each of said first surface of said two plates;
rubbing said polyimide coated upon said first surface of said first plate along a predetermined direction;
rubbing said polyimide coated upon said first surface of said second plate along a direction having a predetermined angle in relation to said predetermined direction;
aligning said first plate and said second plate having said first surface of said first plate and said first surface of said second plate facing each other thereby creating a space there between; and
filling a liquid crystal between said space whereby a cell, or film is created.

2. The method of claim 1, further comprising:
using a mask having alternate transparent and opaque stripes coving said cell or film whereby a solidifying energy are being selectively applied there through; and
partially solidifying some portions said liquid crystal.

3. The method of claim 2, further comprising:
removing said mask; and
heating said cell or film to a temperature set point, whereby unsolidified liquid crystals covered by said opaque stripes are being transformed into a different phase.

4. The method of claim 1, further comprising:
re-solidifying uncured nematics into an isotropic phase.

5. The method of claim 1, further comprising:
substantially solidifying the materials between said first surface of said first plate and the said first surface of said second plate; and
removing said first plate; and
removing said second plate.

6. The method of claim 2, wherein:
said solidifying comprises applying an ultraviolet light.

7. The method of claim 1, wherein:
said space having a substantially equidistance between said first surface of said first plate and said first surface of said second plate.

8. The method of claim 1, wherein:
said liquid crystal comprises a nematic liquid crystal.

9. The method of claim 8, wherein:
said nematic liquid crystal comprises a type of polymerizable nematic liquid crystal.

10. The method of claim 1, wherein: said predetermined angle is about ninety degrees.

11. The method of claim 1, wherein: said predetermined angle is about forty-five degrees.

12. The method of claim 1, wherein:
said two plates comprising flat glass plates.

13. A method for creating a micropolarizer, comprising:
providing a first plate having a first and a second surface, said first surface having an alternatively striped coatings of ITO of a predetermined strip width;
providing a second plate having a first and a second surface, said first surface having coatings of ITO;
coating a polyimide on each of said first surface of said two plates;
rubbing said polyimide coated upon said first surface of said first plate along a predetermined direction;
rubbing said polyimide coated upon said first surface of said second plate along a direction having a predetermined angle in relation to said predetermined direction;
aligning said first plate and said second plate having said first surface of said first plate and said first surface of said second plate facing each other thereby creating a space there between; and
filling a liquid crystal between said space whereby a cell, or film is created.

14. The method of claim 13, further comprising:
using a mask having alternate transparent and opaque stripes coving said cell or film whereby a solidifying energy are being selectively applied there through; and
partially solidifying some portions said liquid crystal.

15. The method of claim 14, further comprising:
removing said mask; and
heating said cell or film to a temperature set point, whereby unsolidified liquid crystals covered by said opaque stripes are being transformed into a different phase.

16. The method of claim 14, further comprising:
re-solidifying uncured nematics into an isotropic phase.

17. The method of claim 13, further comprising:
substantially solidifying the materials between said first surface of said first plate and the said first surface of said second plate;
removing said first plate; and
removing said second plate.

18. The method of claim 13, wherein:
said solidifying comprises applying an ultraviolet light.

19. The method of claim 13, wherein:
said space having a substantially equidistance between said first surface of said first plate and said first surface of said second plate.

20. The method of claim 13, wherein:
said liquid crystal comprising a nematic liquid crystal.

21. The method of claim 20, wherein:
said nematic liquid crystal comprising a type of polymerizable nematic liquid crystal.

22. The method of claim 13, wherein: said predetermined angle is about ninety degrees.

23. The method of claim 13, wherein:
said two plates comprising flat glass plates.

24. A method for creating a micropolarizer, comprising:
providing a first plate having a first and a second surface;
coating a polyimide on said first surface of said first plate;
rubbing said polyimide coated upon said first surface of said first plate along a predetermined direction;
coating a photo resist on top of said polyimide;
patterning said photo resist into a predetermined alternatively spaced strips;
re-rubbing said polyimide coated upon said first surface of said first plate along a direction having a predetermined angle in relation to said predetermined direction; and
rinsing off said photo resist.

25. The method of claim 24, further comprising:
providing a second plate having a first and a second surface;
coating a polyimide on said first surface of said first plate;
rubbing said polyimide coated upon said first surface of said first plate along a predetermined direction;
aligning said first plate and said second plate having said first surface of said first plate and said first surface of said second plate facing each other thereby creating a space there between; and
filling a liquid crystal between said space whereby a cell, or film is created.

26 The method of claim 24, further comprising:
solidifying said liquid crystal.

26. The method of claim 25, further comprising:
substantially solidifying the materials between said first surface of said first plate and the said first surface of said second plate; and
removing said first plate; and
removing said second plate.

27. The method of claim 26, wherein:
said solidifying comprises applying an ultraviolet light.

28. The method of claim 24, further comprising:
re-solidifying uncured nematics into an isotropic phase.

29. The method of claim 28, wherein:
said solidifying comprises applying an ultraviolet light.

30. The method of claim 25, wherein:
said space having a substantially equidistance between said first surface of said first plate and said first surface of said second plate.

31. The method of claim 24, wherein:
said liquid crystal comprising a nematic liquid crystal.

32. The method of claim 31, wherein:
said nematic liquid crystal comprising a type of polymerizable nematic liquid crystal.

33 The method of claim 25, wherein: said predetermined angle is about ninety degrees.

34. The method of claim 25, wherein:
said two plates comprising flat glass plates.

35. A method for creating a micropolarizer, comprising:
providing a first plate having a first and a second surface;
providing a second plate having a first and a second surface;
coating a coat able material on each of said first surface of said two plates;
exposing both plates to a first linearly polarized ultraviolet light;
partially covering said first plate;
re-exposing said first plate to a second polarized ultraviolet light;
aligning said first plate and said second plate having said first surface of said first plate and said first surface of said second plate facing each other thereby creating a space there between; and
filling a liquid crystal between said space whereby a cell, or film is created.

36. The method of 35, wherein:
said second polarized ultraviolet light having a polarization direction substantially perpendicular to the polarization direction of said first linearly polarized ultraviolet light

37. The method of claim 35, wherein:
said coat able material consists of polyvinyl 4-methoxycinnamate (PVMC), polyvinylcinnamates (PVC), polyimides, dyed polyimide, and azobenzene polymer.

38. The method of claim 35, wherein:
said space having a substantially equidistance between said first surface of said first plate and said first surface of said second plate.

39. The method of claim 35, wherein:
said liquid crystal comprising a nematic liquid crystal.

40. The method of claim 39, wherein:
said nematic liquid crystal comprising a type of polymerizable nematic liquid crystal.

41. The method of claim 35, wherein:
said liquid crystal is mixed with a small amount of photoresist PVMC or azo dye.

42. A method for creating a micropolarizer, comprising:
providing a first plate having a first and a second surface;
providing a second plate having a first and a second surface;
coating a coat able material on each of said first surface of said two plates;
exposing said first plate to a first linearly polarized ultraviolet light;
placing a mask over said second plate;
exposing said second plate to said first linearly polarized ultraviolet light;
partially covering said first plate;
translationally moving said mask a predetermined distance;
re-exposing said first plate to a second polarized ultraviolet light;
aligning said first plate and said second plate having said first surface of said first plate and said first surface of said second plate facing each other thereby creating a space there between; and
filling a liquid crystal between said space whereby a cell, or film is created.

43. The method of claim 42, wherein:
said second polarized ultraviolet light having a polarization direction substantially perpendicular to the polarization direction of said first linearly polarized ultraviolet light

44. The method of claim 42, wherein:
said coat able material consists of polyvinyl 4-methoxycinnamate (PVMC), polyvinylcinnamates (PVC), polyimides, dyed polyimide, and azobenzene polymer.

45. The method of claim 42, wherein:
said space having a substantially equidistance between said first surface of said first plate and said first surface of said second plate.

46. The method of claim 42, wherein:
said liquid crystal comprising a nematic liquid crystal.

47. The method of claim 46, wherein:
said nematic liquid crystal comprising a type of polymerizable nematic liquid crystal.

48. The method of claim 42, wherein:
said two plates comprising flat glass plates.

49. The method of claim 42, wherein: said liquid crystal is mixed with a small amount of photoresist PVMC or azo dye.

50. A liquid crystal display device, comprising:
an input surface for receiving incident light;
an output surface for emanating a processed light; and
a micropolarizer based on twist nematic liquid crystals produced by a method comprising a liquid crystal display device produced by the method described substantially by claims 1-11.

51. A twisted nematic micropolarizer, comprising:
a first plate having a first and a second surface;
a second plate having a first and a second surface;
material coated on each of said first surface of said two plates;
a space there between said first plate and said second plate having said first surface of said first plate and said first surface of said second plate facing each other; and
a liquid crystal filling said space whereby a cell, or film is created.

51. The device of claim 51, wherein:
said coating material comprises polyvinyl 4-methoxycinnamate (PVMC), polyvinylcinnamates (PVC), polyimides, dyed polyimide, and azobenzene polymer.

52. The device of claim 51, wherein:
said space has a substantially equidistance between said first surface of said first plate and said first surface of said second plate.

53. The device of claim 51, wherein:
said liquid crystal comprises a nematic liquid crystal.

54. The device of claim 51, wherein:
said nematic liquid crystal comprises a type of polymerizable nematic liquid crystal.

55. The device of claim 51, wherein:
said two plates comprise flat glass plates.

56. The device of claim 51, wherein: said liquid crystal is mixed with a small amount of photoresist PVMC or azo dye.

57. The device of claim 51 wherein said TN-micropol is horizontally aligned.

58. The device of claim 51 wherein csid TN-mcropol is vertically aligned.

59 The device of claim wherein said TN-micropol is aligned vertically and horizontally in a checkerboard pattern.
